(19) United States
(12) Patent Application Publication
(10) Pub. No.: US 2012/0150877 A1
(43) Pub. Date: Jun. 14, 2012

(54) EFFICIENT DATABASE COMPRESSION

(75) Inventors: Ravishankar Ramamurthy, Redmond, WA (US); Abhijeet Mohapatra, Stanford, CA (US)

(73) Assignee: MICROSOFT CORPORATION, Redmond, WA (US)

(21) Appl. No.: 12/964,549

(22) Filed: Dec. 9, 2010

(51) Int. Cl. G06F 17/30

(52) U.S. Cl. 707/752; 707/E17.104

(57) ABSTRACT

A method for compressing data. The method includes accessing, within an electronic system, a database relation comprising a plurality of attributes and determining a sort order of the plurality of attributes of the database relation. The method further includes determining an order of a plurality of compression operators operable to compress the database relation and compressing the database relation to produce a compressed database based on the sort order and the order of the plurality compression operators.

### BACKGROUND

The widespread use and rapid development of the computer technology has allowed computer systems to perform an increasing variety of tasks. Databases have become central to the performance of many computer system functions and store increasingly large amounts of data for increasingly powerful applications. As a consequence, storage demands to support databases have grown in a similar manner.

Backing up databases is important for protecting against system failures, disasters, and storing data for future access. As databases have become increasingly large, the storage requirements for storage of archived database data has correspondingly increased. Conventional solutions have used general purpose compression programs to compress the databases, which view all files as a sequence of bytes. Unfortunately, such general purpose compression programs are not well suited to efficiently compress databases.

Thus, what is needed is a way to efficiently compress databases for archival or backup purposes.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, compressing databases. It involves various techniques for compressing database data based on the contents of the database. Database data is sorted and an order of compression operators is determined based on the data of the database and used to compress the data. The database data may then be further compressed via use of a general purpose compressor. Therefore, the technology allows for compression of database data based on the contents of the database.

In one implementation, a method for compressing data may be used to compress database data. The method includes accessing, within an electronic system, a database relation comprising a plurality of attributes and determining a sort order of the plurality of attributes of the database relation. The method further includes determining an order of a plurality of compression operators operable to compress the database relation and compressing the database relation to produce a compressed database based on the sort order and the order of the plurality compression operators. Thus, the compression is customized for the data of the database.

Techniques described herein provide a way for efficiently compressing database data. Thus, compression better than general purpose compressors is achieved.

### BRIEF DESCRIPTION OF THE DRAWINGS

The accompanying drawings, which are incorporated in and form a part of this specification, illustrate embodiments and, together with the description, serve to explain their principles:

FIG. 1 is a flowchart of an exemplary process for compressing database data, in accordance with an embodiment.

FIG. 2 is a flowchart of an exemplary process for sorting database data, in accordance with an embodiment.

FIG. 3 is a flowchart of an exemplary process for determining a compression operator order, in accordance with an embodiment.

FIG. 4 is a flowchart of an exemplary process for performing decompression, in accordance with an embodiment.

FIG. 5 is a block diagram of an exemplary system for compressing and decompressing database data, in accordance with an embodiment.

FIG. 6 is a block diagram of an exemplary computing system environment for implementing an embodiment.

### DETAILED DESCRIPTION

Reference will now be made in detail to the embodiments of the claimed subject matter, examples of which are illustrated in the accompanying drawings. While the invention will be described in conjunction with the embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the claims. Furthermore, in the detailed description of the present invention, numerous specific details are set forth in order to provide a thorough understanding of the claimed subject matter. However, it will be obvious to one of ordinary skill in the art that the claimed subject matter may be practiced without these specific details. In other instances, well known methods, procedures, components, and circuits have not been described in detail so as not to unnecessarily obscure aspects of the claimed subject matter.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the claimed subject matter.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

### Overview

Described herein is technology for, among other things, compressing databases. It involves various techniques for compressing database data based on the contents of the database. Database data is sorted and an order of compression operators is determined based on the data of the database and used to compress the data. The database data may then be further compressed via use of a general purpose compressor. Therefore, the technology allows for compression of database data based on the contents of the database.

In one implementation, a method for compressing data may be used to compress database data. The method includes accessing, within an electronic system, a database relation comprising a plurality of attributes and determining a sort order of the plurality of attributes of the database relation. The method further includes determining an order of a plurality of compression operators operable to compress the database relation and compressing the database relation to produce a compressed database based on the sort order and the order of the plurality compression operators. Thus, the compression is customized for the data of the database.

Techniques described herein provide a way for efficiently compressing database data. Thus, compression better than general purpose compressors is achieved.

### EXAMPLE OPERATIONS

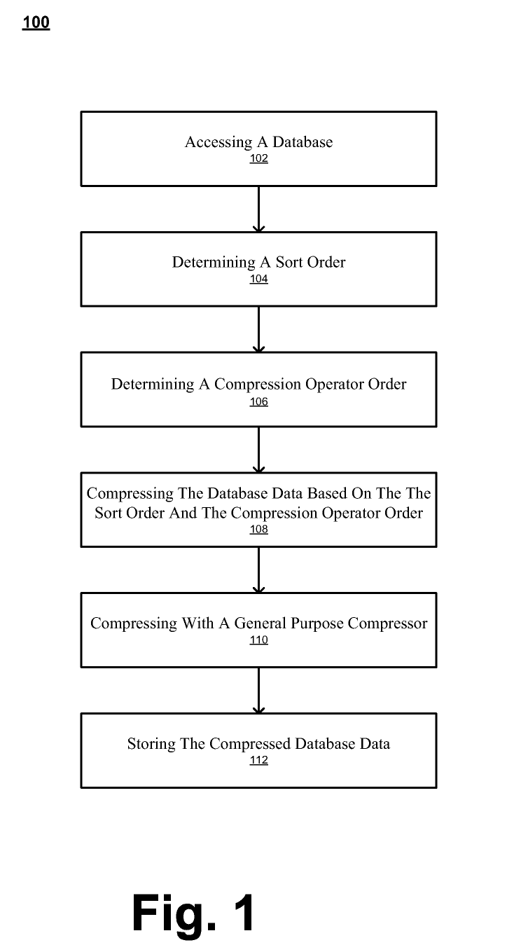

The following discussion sets forth in detail the operations of the present technology for compression and decompression of database data. With reference to FIGS. 1-4, flowcharts 100-400 each illustrate example blocks used by various embodiments of the present technology. Flowcharts 100-400 include processes that, in various embodiments, are carried out by a processor under the control of computer-readable and computer-executable instructions.

FIG. 1 is a flowchart of an exemplary process for compressing database data, in accordance with an embodiment. Process 100 may be performed to archive or backup data and minimize the storage being used to backup the data.

At block 102, a database is accessed. The database may include one or more relations (e.g., tables) each having one or more attributes (e.g., columns). Each relation may further include a plurality of tuples (e.g., rows) which comprise the data stored in the database.

At block 104, a sort order for the database data is determined In one embodiment, the sort order for the database is determined to minimize the number of runs (e.g. sequences of data having the same value). This sort order may be determined to maximize the compressed output of the compression operators, as described herein. In one embodiment, the sort order is determined that best exposes runs of attribute values.

At block 106, a compression operator order is determined In one embodiment, a compression operator order or compression plan including an ordering of a plurality of compression operators is determined to maximize the compression of the database table. The compression operator order may include an ordering of compression operators including, but not limited to, run-length encoding (RLE), delta coding, and dictionary coding to be used in compressing the database.

At block 108, the database table is compressed based on the sort order and the compression operator order. In one embodiment, the data may be compressed with a file for each attribute or groups of attributes of the relation.

RLE can be used to compress a sequence with large runs compactly using pairs (e.g., value, count pairs) and delta coding can be used effectively when the difference between successive values in the sequence is small. In one embodiment, processing with RLE splits an input into two files: a data file and a runs file. A run of identical consecutive values in the input file is replaced by the value in the data file and the corresponding count in the runs file.

In one embodiment, dictionary coding is used to process the input, substituting the values in the input with their fixed length encoded variants. The encoded file can be treated as a sequence of one byte integers. Embodiments are operable to use dictionary coding with fixed or variable length encoding. It is appreciated that embodiments are operable to use RLE, delta coding, and dictionary coding with files and sets of files.

Embodiments may further support operators for vertical and horizontal partitioning. For example, vertical partitioning of a relation may allow exploiting correlation between attribute values.

At block 110, the database table is optional compressed with a general purpose compression program. Embodiments may use the general compressors including, but not limited to, WinZip available from the Corel Corporation of Ottawa, Ontario, Canada and gzip, available from the GNU Project.

At block 112, the compressed database data is stored. The compressed database may be stored at a local location or a remote location from the database. The compressed database table may be stored with metadata describing any restructuring operators (such as sort order) and compression operator order to allow decompression of the database table.

Embodiments support numerical attributes, text, and date values. For example, attribute values with date-time type may be converted to integer values by taking deltas from their respective minimum values. Text-like attributes may be compressed using RLE and dictionary coding and delta coding may further be used after dictionary coding of a text attribute.

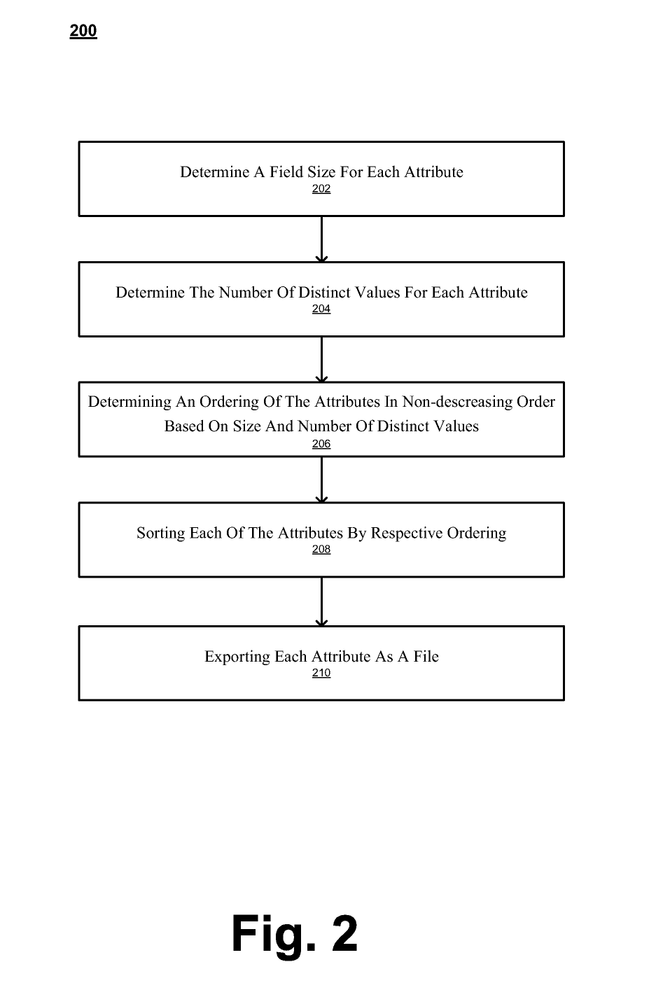

FIG. 2 is a flowchart of an exemplary process for sorting database data, in accordance with an embodiment. Process 200 is performed to determine a sort order for a database table (e.g., block 104). Embodiments are thus operable to utilize the fact that the ordering of tuples can especially enhance the effectiveness of compression techniques (e.g., run-length encoding (RLE) and delta coding that look at runs and differences across successive values respectively). For example, RLE and delta coding can be particularly effective for large patterns.

At block 202, a field size is determined for each attribute of a database table. The size may correspond to the size in bytes of each attribute.

At block 204, the number of distinct values for each attribute is determined For example, the number of distinct values for each attribute of a plurality of tuples is determined

At block 206, an ordering of the attributes in non-decreasing order based on size of the attribute and the number of distinct values for each value is determined In one embodiment, the attributes are ordered based on a greedy order of the size of an attribute multiplied by the number of distinct values for that attribute. The order of the attributes may thus minimize the number of runs across the attributes which thereby improves RLE compression. In order words, the length of runs is maximized thereby allowing the maximum compression possible via RLE.

At block 208, each of the attributes is sorted by the respective ordering.

At block 210, each attribute is exported as a file. In one embodiment, each of the attributes is stored as a separate file.

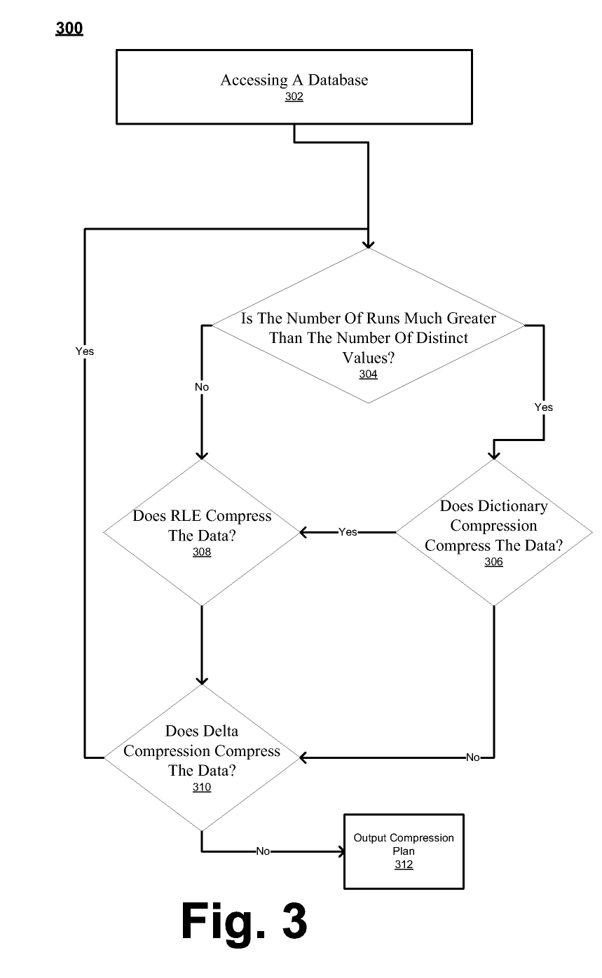

FIG. 3 is a flowchart of an exemplary process for determining a compression operator order, in accordance with an embodiment. A compression operator order or compression plan is a composition of compression operators that can be used to compress data. In one embodiment, a compression plan is a sequence operations to perform compression, determined in a specific fashion for each relation, attribute, or set of attributes of a database. Compression plans are data dependent or customized for the data. Embodiments can thus produce different compression plans for different tables or even attributes of the same table. Process 300 is performed to determine a compression operator order (e.g., block 106).

Embodiments effectively utilize compositions of compression operators. It is appreciated that the compositions of multiple compression operators including, but not limited to, RLE, delta coding, and dictionary coding can result in higher compression ratios than those obtained using the respective operators alone.

In one embodiment, a compression plan is a tree of compression operators that compresses an input into a set of compressed files. The depth of the compression plan can be specified by the height of the tree of compression operators. The maximum depth of a compression plan may be a user configurable parameter or predetermined (e.g., default) value. Compression based on the compression plan may thus be performed to the specified depth. Embodiments are thus able to obtain the optimal compression plan whose depth is less than the specified depth by leveraging a greedy sort order and using determining a suitable composition of the compression operators.

Embodiments may display estimates of the compression times and the compression ratios at different compression depths. Estimates may be based on compression on a random sample of the input relation.

Embodiments may further enable incremental compression of relations. For example, for a batch of inserts to the original relation, compression plans that are incrementally maintainable may be used.

At block 302, a database is accessed. In one embodiment, each attribute (e.g., column) may be a separate file.

At block 304, whether the number of runs is much greater than the number of distinct values is determined In one embodiment, the number of distinct values in an attribute is compared to the number of runs after sorting of the relation (e.g., block 104). If the ratio of the number of runs to the distinct values is high (e.g., the attribute is sufficiently randomized), block 306 is performed which can enable compression using compositions of RLE and delta coding. If the number of runs is not much greater than the number of distinct values, block 308 is performed.

At block 306, whether dictionary coding compresses the database table is determined If dictionary coding compresses the database (e.g., result in a non-negative compression ratio), dictionary coding is added to the compression plan and block 308 is performed. If dictionary coding does not compress the database, block 310 is performed. Dictionary coding may be used to compress attributes having few distinct values but a large number of runs.

At block 308, whether run-length encoding (RLE) compresses the data is determined If RLE results in a non-negative compression ratio then RLE is added to the compression plan. For example for a key column having 100 tuples, delta coding will result in ones between each successor. Then run-length encoding may be performed resulting in a value of 1 repeated 100 times. Then the entire sequence of one to 100 becomes two number with a compression operator ordering. Block 310 is then performed.

At block 310, whether delta coding compresses the data is determined For example, where a table contains a ship date and an order date columns, the values of each column are likely to be within a close range of each other. Delta coding would thus be effective for compressing the ship date and order date columns. If delta coding compresses the data, delta coding is added to the compression plan and block 304 is performed. If delta coding does not compress the data, block 312 is performed.

It is appreciated that whenever RLE and delta coding result in non-negative compression ratios, embodiments will give RLE a higher precedence. Embodiments are operable prefer RLE over delta coding whenever delta coding minimizes the maximum difference across successive values and RLE gives a non-negative compression ratio.

At block 312, the compression plan is output. The compression plan, comprising the ordering of the compression operator, is stored and can then be used to compress the data (e.g., block 108 of process 100). Embodiments thus assemble the order of compression operators based on actual data patterns.

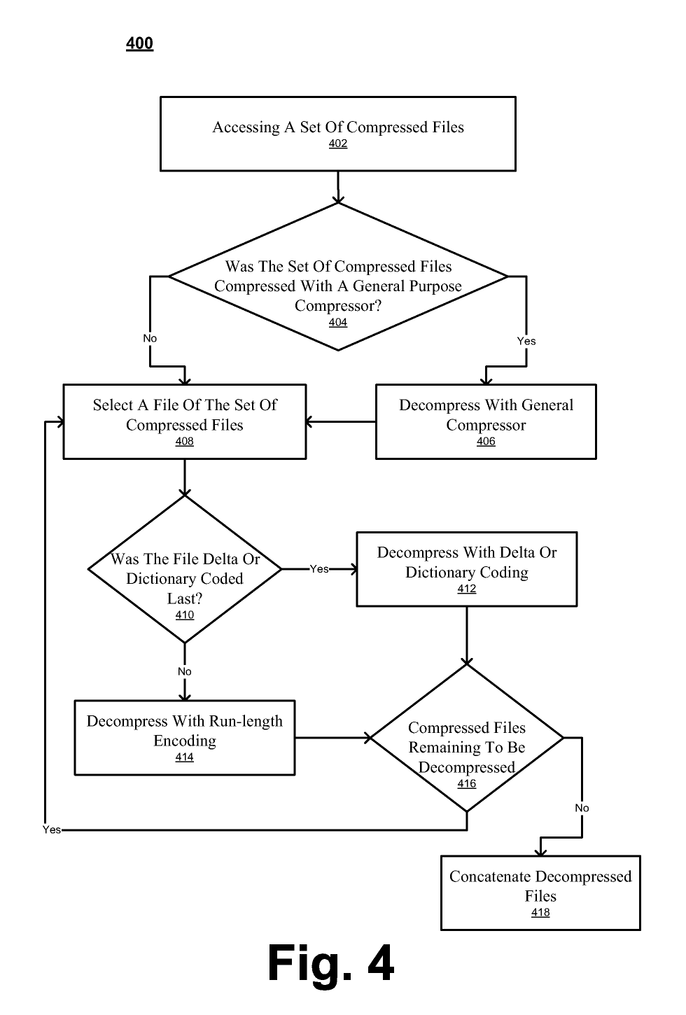

FIG. 4 is a flowchart of an exemplary process for performing decompression, in accordance with an embodiment. Embodiments are operable to compress a relation in a lossless manner with the compression operators: RLE, delta, dictionary coding and general purpose compressors. It is appreciated that sorting does not create any decompression issues because the sorted and unsorted relation are equivalent. The decompression of a compressed set of files can involve executing decompression schemes for each compression operator in reverse order of the corresponding compression plan.

At block 402, a set of compressed files is accessed. As described herein, each file of the set of files may correspond to an attribute of a relation. In one embodiment, a single file may include the compressed database relation so a single file may be accessed.

At block 404, whether the set of files was compressed with a general purpose compressor is determined If the set of files was compressed with a general compressor, block 406 is performed.

At block 406, the set of files is decompressed using the corresponding general compressor program. For example, Winzip may be used to decompress the set of files.

If the set of files was not compressed with a general compressor, block 408 is performed. At block 408, a file of the set of files is selected.

At block 410, whether a file was delta or dictionary coded last is determined. If the file was delta or dictionary coded last, block 412 is performed. If the file was not delta or dictionary coded last, block 414 is performed.

At block 412, the file is decompressed with delta or dictionary coding. At block 414, the file is decompressed with run-length encoding. In one embodiment, the RLE compressed file is decompressed using values from the file and their respective counts of the runs.

At block 416, whether there are compressed files remaining to be decompressed is determined If files remain to be decompressed, block 408 is performed. If set of files has been decompressed, block 418 is performed.

At block 418, the decompressed files are concatenated. In one embodiment, the files are concatenated horizontally to produce the relation.

### EXAMPLE SYSTEM

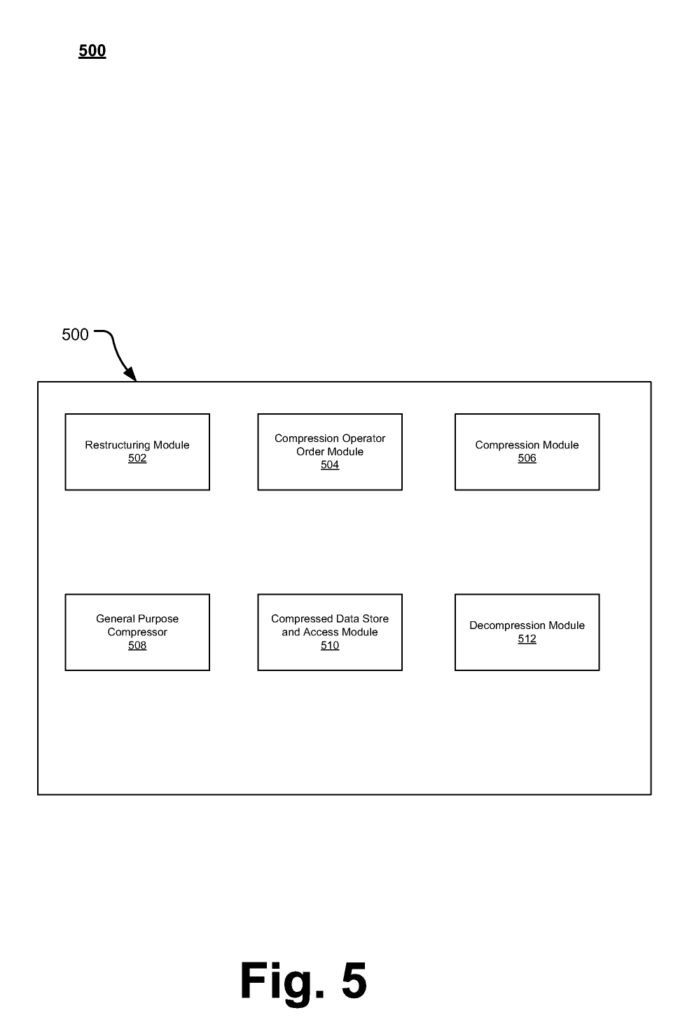

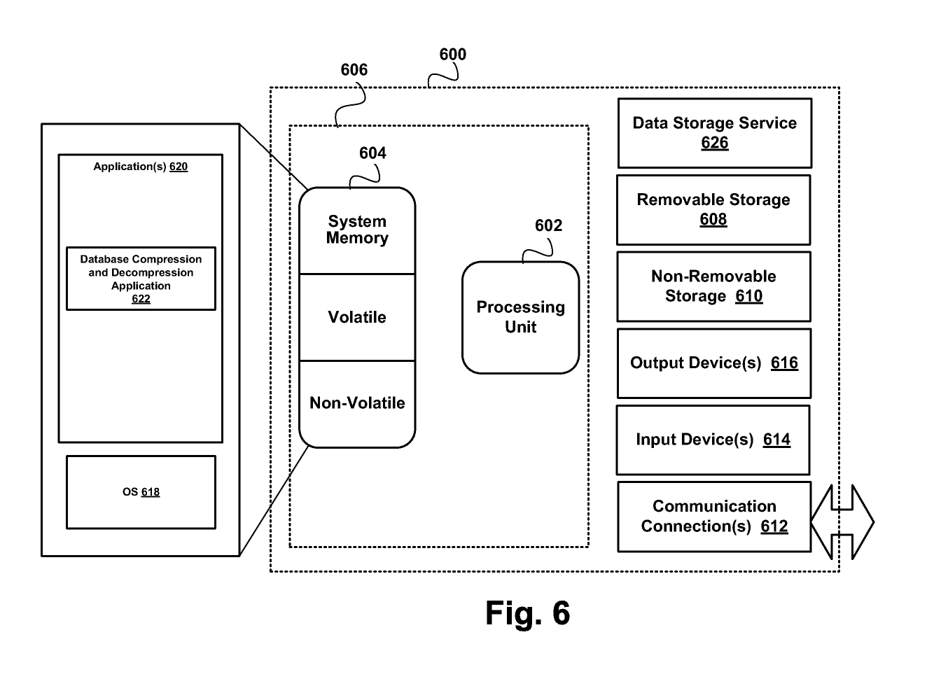

The following discussion sets forth details of the present technology systems for network communication management. FIG. 5 illustrates example components used by various embodiments of the present technology. System 500 includes components or modules that, in various embodiments, are carried out by a processor under the control of computer-readable and computer-executable instructions. The computer-readable and computer-executable instructions reside, for example, in data storage features such as computer usable memory 604, removable storage 608, and/or non-removable storage 610 of FIG. 6. The computer-readable and computer-executable instructions are used to control or operate in conjunction with, for example, processing unit 602 of FIG. 6. It should be appreciated that the aforementioned components of system 500 can be implemented in hardware or software or in a combination of both. Although specific components are disclosed in system 500 such components are examples. That is, embodiments are well suited to having various other components or variations of the components recited in system 500. It is appreciated that the components in system 500 may operate with other components than those presented, and that not all of the components of system 500 may be required to achieve the goals of system 500.

FIG. 5 is a block diagram of an exemplary system for compressing and decompressing database data, in accordance with an embodiment. System 500 includes restructuring module 502, compression operator order module 504, compression module 506, general purpose compressor module 508, compressed data store and access module 510, and decompression module 512.

Restructuring module 502 is operable to sort and horizontal and/or vertically partition a relation (e.g., table of a database), as described herein. Compression operator order module 504 is operable to determine a compression plan or composition of compression operators for compressing a database, as described herein. Compression module 506 is operable to compress data (e.g., a relation) based on the compression plan determined by compression operator order module 504. Compressed data store and access module 510 is operable to store and to access data compressed via compression module 506.

General purpose compressor module 508 is operable to use a general purpose compressor to compress and decompress files, as described herein. Decompression module 512 is operable to decompress one or more files compressed via a compression plan, as described herein.

### EXAMPLE OPERATING ENVIRONMENTS

With reference to FIG. 6, an exemplary system for implementing embodiments includes a general purpose computing system environment, such as computing system environment 600. Computing system environment 600 may include, but is not limited to, servers, desktop computers, laptops, tablet PCs, mobile devices, and smartphones. In its most basic configuration, computing system environment 600 typically includes at least one processing unit 602 and memory 604. Depending on the exact configuration and type of computing system environment, memory 604 may be volatile (such as RAM), non-volatile (such as ROM, flash memory, etc.) or some combination of the two. This most basic configuration is illustrated in FIG. 6 by dashed line 606.

System memory 604 may include, among other things, Operating System 618 (OS), application(s) 620, and database compression and decompression application 622. Database compression and decompression application 622 are operable to compress and decompress database data via sorting and performing compression based on a composition of compression operators (e.g., RLE, delta coding, and dictionary coding). Database compression and decompression application 622 compresses data based on a composition of compression operators selected based on the data of the database.

Additionally, computing system environment 600 may also have additional features/functionality. For example, computing system environment 600 may also include additional storage (removable and/or non-removable) including, but not limited to, magnetic or optical disks or tape. Such additional storage is illustrated in FIG. 6 by removable storage 608, non-removable storage 610, and data storage service 626. Data storage service 626 may provide storage for service applications and be in a variety of storage configurations including but not limited to, remote and distributed storage. Computer storage media includes volatile and nonvolatile, removable and non-removable media implemented in any method or technology for storage of information such as computer readable instructions, data structures, program modules or other data. Memory 604, removable storage 608, nonremovable storage 610, and data storage 626 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 600. Any such computer storage media may be part of computing system environment 600.

Computing system environment 600 may also contain communications connection(s) 612 that allow it to communicate with other devices. Communications connection(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 612 may allow computing system environment 600 to communication over various networks types including, but not limited to, Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 612 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 600 may also have input device(s) 614 such as a keyboard, mouse, pen, voice input device, touch input device, remote control, etc. Output device(s) 616 such as a display, speakers, etc. may also be included. All these devices are well known in the art and need not be discussed at length here.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for compressing data comprising:
accessing, within an electronic system, a database relation comprising a plurality of attributes;
determining a sort order of said plurality of attributes of said database relation;
determining an order of a plurality of compression operators operable to compress said database relation; and
compressing said database relation to produce a compressed database data based on said sort order and said order of said plurality compression operators.

2. The method as recited in claim 1 further comprising:
compressing said compressed database data with a general purpose compressor.

3. The method as recited in claim 1 wherein said plurality of compression operators comprises run-length encoding.

4. The method as recited in claim 3 wherein said plurality of compression operators further comprises delta coding.

5. The method as recited in claim 4 wherein said plurality of compression operators further comprises dictionary coding.

6. The method as recited in claim 1 further comprising:
restructuring said database relation based on one or more restructuring operators.

7. The method as recited in claim 6 wherein said restructuring operators comprises a first operator for vertically partitioning said database relation and a second operator for horizontally partitioning said database relation.

8. The method as recited in claim 1 wherein said compressed database data comprises a plurality of files, wherein each file of said plurality of files corresponds a respective attribute or a group of attributes of said plurality of attributes.

9. The method as recited in claim 1 wherein said order of said plurality of compression operators is determined based on the field size of each of said plurality of attributes.

10. The method as recited in claim 9 wherein said order of said plurality of compression operators is determined based on the number of distinct values for each of said plurality of attributes.

11. An apparatus for compressing database data comprising:
a restructuring module for restructuring a database relation;
a compression operator order module for determining an order of a plurality of compression operators; and
a compression module operator for compressing said database relation to produce a compressed database relation based on said order of compression operators and said structuring of said database relation.

12. The apparatus as recited in claim 11 further comprising:
a general purpose compressor operable to compress said compressed database relation.

13. The apparatus as recited in claim 11 further comprising:
a decompression module for decompressing said compressed database relation based on said restructuring of said database relation and said order of said plurality of compression operators.

14. The apparatus as recited in claim 11 wherein said plurality of compression operators is selected from the group consisting of run-length encoding, delta coding, and dictionary coding.

15. The apparatus as recited in claim 11 wherein said restructuring module is operable to horizontally partitioning said database relation.

16. The apparatus as recited in claim 11 wherein said order of said plurality of compression operators comprises a tree of compression operators.

17. The apparatus as recited in claim 16 wherein said order of said plurality of compression operators is based on a predetermined depth of said tree or based on a random sample of said database.

18. A method for compression a database comprising:
accessing a database relation, wherein said database relation comprises an attribute;
determining a sort order for a plurality of tuples corresponding to said attribute of said database relation;
determining a compression operator order for compressing said attribute of said database relation; and
compressing said attribute based on said compression operator order.

19. The method of claim 18 wherein said compression operator order is determined based on a number of runs for said attribute being greater than a number of distinct values of said attribute.

20. The method of claim 18 wherein said sort order is based on a minimum number of runs of said attribute.
